(19) United States
(12) Patent Application Publication
(10) Pub. No.: US 2014/0164341 A1
(43) Pub. Date: Jun. 12, 2014

(54) METHOD AND APPARATUS FOR OBTAINING AND MANAGING CONTACT INFORMATION

(71) Applicant: VONAGE NETWORK LLC, Holmdel, NJ (US)

(72) Inventors: MICHAEL BARATTA, TOMS RIVER, NJ (US); TZAHI EFRATI, HOBOKEN, NJ (US)

(73) Assignee: VONAGE NETWORK LLC, Holmdel, NJ (US)

(21) Appl. No.: 13/711,181

(22) Filed: Dec. 11, 2012

(51) Int. Cl. G06F 17/30

(52) U.S. Cl. CPC G06F 17/30312
USPC 707/706; 707/812

(57) ABSTRACT

A method and apparatus for populating a contact in an address book on a mobile computing device. In some embodiments, the method includes receiving data associated with a first entity, processing the data received to extract contact information associated with the first entity, populating a user contact entry based on the extracted contact information, and storing the populated user contact in the address book.

### BACKGROUND OF THE INVENTION

1. Field of the invention

Embodiments consistent with the present invention generally relate to methods and apparatus for obtaining and managing contact information for various entities.

2. Description of the Related Art

A typical mobile phone user may come into the physical vicinity of businesses, etc., that the user may wish to store in their contact book, dial at that moment, and/or may want other information about the business. To do so, the user may need to go through the cumbersome process of looking for the establishment's information, and then enter it into the user's contact book. Furthermore, that information may not be readily visible on the physical establishment itself (such as on a sign). If the user happens to possess a smartphone or other mobile computing device, the user may conduct an Internet search to determine the contact information for the business. This too, however, may be cumbersome since the business may be part of a franchise, with multiple locations, or the search may otherwise pull up any number of off-point results, requiring parsing through the results to obtain the correct information.

Thus there is a need for a method and apparatus to provide a better way of obtaining and managing contact information for various entities (e.g., businesses, establishments, other people, etc.).

### SUMMARY OF THE INVENTION

A method and apparatus for populating a contact in an address book on a mobile computing device. In some embodiments, the method includes receiving data associated with a first entity, processing the data received to extract contact information associated with the first entity, populating a user contact entry based on the extracted contact information, and storing the populated user contact in the address book.

In some embodiments, a method for obtaining, by a mobile computing device, contact information of an entity based on a location of the entity in proximity to the end user device includes performing a search operation of geolocation information associated with a plurality of entities using geolocation information of the mobile computing device, determining a set of entities of the plurality of entities that are within a predetermined distance threshold from the mobile computing device, sending contact information associated with the set of entities to the mobile computing device, populating one or more user contact entries based on the contact information sent, and storing the populated one or more user contact entries in the address book.

In some embodiments, an apparatus for populating a contact in an address book on a mobile computing device includes at least one processor, at least one input device, and at least one storage device storing processor executable instructions which, when executed by the at least one processor, perform a method including receiving data associated with a first entity, processing the data received to extract contact information associated with the first entity, populating a user contact entry based on the extracted contact information, and storing the populated user contact in the address book.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for populating a contact in an address book on a mobile computing device, according to one or more embodiments of the invention;

FIGS. 2A and 2B depict exemplary Quick Response (“QR”) codes and barcodes used in accordance with embodiments consistent with the present application;

FIG. 3 depicts a system for obtaining, by mobile computing device, contact information of one or more entities based on a location of the one or more entities in proximity to the mobile computing device, according to one or more embodiments of the invention;

FIG. 4 a flow diagram of a method for populating a contact in an address book on a mobile computing device, according to one or more embodiments of the invention; and

FIG. 5 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention include a method and apparatus for obtaining and managing contact information for various entities. Some exemplary embodiments consistent with the claimed invention improve upon standard address book functionality by providing additional flexibility in the way contacts are obtained, contacted, and managed in the address book.

Various embodiments of an apparatus and method for obtaining and managing contact information for various entities are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

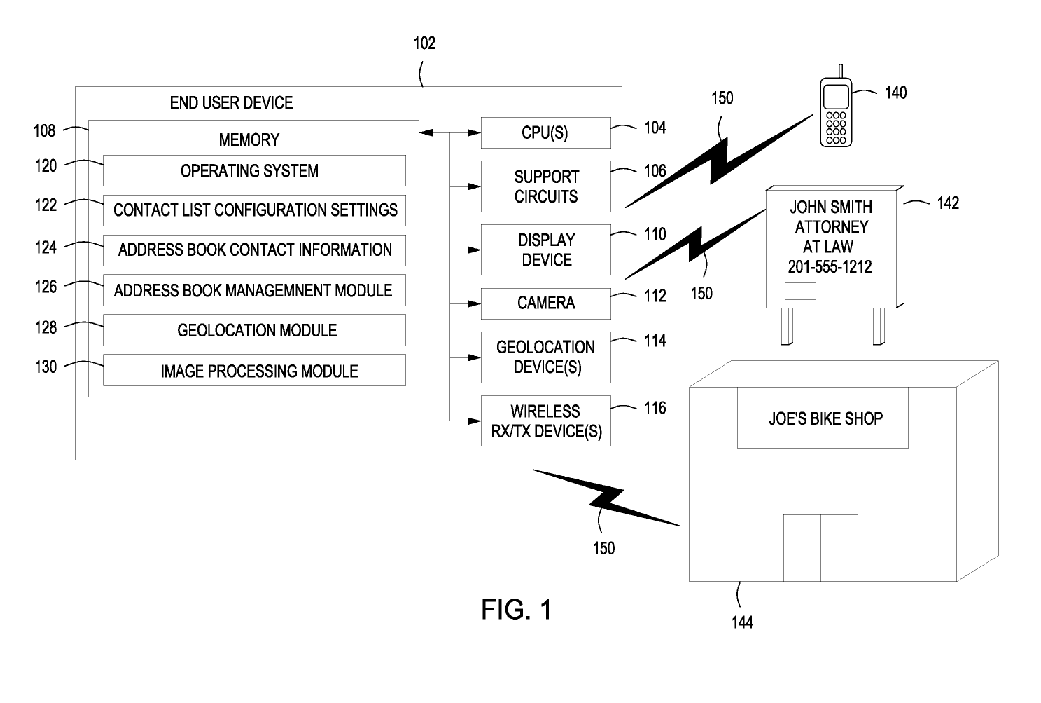

FIG. 1 depicts a block diagram of end user device 102 for obtaining and managing contact information for various entities using end user device 102, according to one or more embodiments. The end user device 102 comprises Central Processing Unit (CPU) 104, support circuits 106, a memory 108, a display device 110, camera 112, geolocation devices 114, and wireless transmission and receiving devices 116 (e.g., WiFi, Bluetooth, etc.). The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 106 comprises at least one of Read Only Memory (ROM), Random Access Memory (RAM), disk drive storage, optical storage, removable storage and/or the like. In some embodiments, the display device 110 may be a touch screen able to accept input from a user's finger or input from a stylus. In some embodiments, the memory 108 comprises an operating system 120, contact list configuration settings 122, one or more address books containing contact information 124, one or more address book management modules 126, one or more location determination modules 128, and one or more image processing modules 130. In some embodiments, some or all of the information and modules described above may be stored remotely on a remote server (not shown) and retrieved from the remote server by the end user device 102 when needed.

The operating system (OS) 120 generally manages various computer resources (e.g., network resources, file processors, and/or the like). The operating system 110 is configured to execute operations on one or more hardware and/or software modules, such as Network Interface Cards (NICs), hard disks, virtualization layers, firewalls and/or the like. Examples of the operating system 120 may include, but are not limited to, Linux, Mac OSX, BSD, Unix, Microsoft Windows, and the like.

In exemplary embodiments consistent with the present invention, a user of user device 102 may obtain contact information from one or more entities via one or more information transfer means 150. In some embodiments, the one or more entities may include business establishments, schools, libraries, billboards or other signage, product displays, other mobile computing devices, vehicles (e.g., a taxi), or any other type of entity that may have contact information associated with it.

In some embodiments, the information transfer means 150 may include wired and/or wireless data transfer of the contact information. Some examples of exemplary wireless transmission methods that may be used include WiFi, BLUETOOTH, Radio-frequency identification (RFID) and Near Field Communications (NCF). For example, mobile device 140, billboard 142, and business establishment 144 may broadcast contact and other information via WiFi or BLUETOOTH as the information transfer means 150. End user device may receive the broadcast information using wireless RX/TX transfer device 116. The received information may be parsed and processed via address book management module 126, a contact entry may be created, and the contact entry may be stored in address book 124. It is noted that end user device 102 may include more than one address book management module 126, and more than one address book 124. For example, a native address book 124 and address book management module 126 may be used, or, an address book 124 and address book management module 126 associated with some installed application using an API to manipulate contacts may be used. In some embodiments, the format of the contact information transferred may be in a predetermined standard format/protocol recognizable by the end user device. For example, exemplary formats/protocols used may include a Type-Length-Value (TLV), XML, JS, VCard, and the like. In some embodiments, before the information is entered into the address book as a new contact, or add to an existing contact, the user of end user device 102 may be given an option as to whether they want to add the contact in the address book.

In some embodiments, the entity broadcasting their contact information may do so selectively based on a mobile user's location (which may be determined using GPS, WiFi triangulations, cell tower ID, NFC, and the like). For example, when a user attempts to access the internet within a store, an access point may present a Web page to the user. The web page can provide contact information that the user could then save into an address book. In some embodiments, an NFC tag can simply transmit contact information when a user taps their device on or near the tag. Similarly, a BLUETOOTH access point can send a contact information card to a user device when the device's BLUETOOTH is in discovery mode.

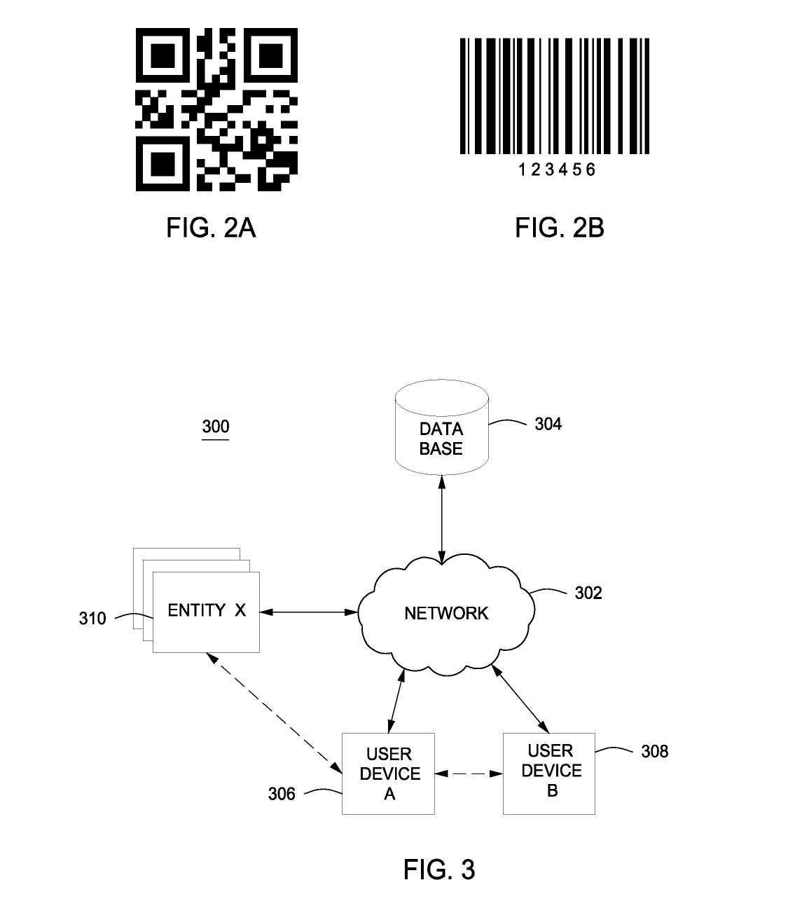

In some embodiments, the contact information transfer means 150 may include image data associated with a contact acquired using camera 112. For example, a user of end user device 102 may take a picture using camera 112 of the information displayed on billboard 142, or of the name of business establishment 144 (i.e., “Joe's Bike Shop”). The user of end user device 102 may scan a Quick Response (“QR”) code 202 or a barcode 204 as shown in FIGS. 2A and 2B using camera 112. The image data acquired may be processed using the image processing modules 130 on user device 102. For example, image processing modules 130 may include Optical Character Recognition (OCR) software to extract information from images of plain text language, or QR or barcode recognition software to extract information from QR code 202 or barcode 204. A contact entry may be created using the extracted information. In some instances, however, the information extracted may be used as search criteria, along with location coordinates of the user device, to lookup the contact information of the entity in question. The result of the search could then be used to create a contact entry to be stored in address book 124 or to directly contact/dial the entity if applicable. For example, if a user passes billboard 142 and is interested in contacting attorney John Smith, the user may take a picture of John Smith's information displayed on billboard 142. The image data would be processed and OCR'd, for example, to extract the name, “John Smith” and phone number, “201-555-1212.” A contact entry would be created and the end user device could contact John Smith directly at that time and/or store the contact entry in the address book depending on the user's preference/feedback.

In some embodiments, the image data acquired may be sent to a remote cloud based server for processing, and a completed contact entry may be sent to end user device 102. As discussed above, before the information is entered into the address book as a new contact, the user of end user device 102 may be given an option as to whether they want to add the contact in the address book. In some embodiments, feedback from the user regarding whether the user added the contact to the address book is provided back to the remote cloud based server. The server may then use that feedback to determine if the contact information should be sent for similar queries by other devices. In addition, the user of end user device 102 may be given an option as to whether they want to contact the entity at that time.

FIG. 3 depicts system 300 that includes a database 304 of information including GPS information associated with various entities 310 may be accessible to users of user device A 306 and user device B 308 via network 302. The information in database 304 may be continually updated with geolocation information about the various entities 310. In some embodiments, a user may execute a query for information associated with one or more entities 310 on a user device 306, 308. The query may include geolocation information (e.g., GPS coordinates and the like) associated with the request. A list of businesses that fall within a certain distance of user device 306, 308 may be provided to the users of user device 306, 308. The list of business may be filtered or ordered based on user-specific information (e.g., age, gender, and the like). One or more of the list of businesses returned to the user may by auto-dialed in response to query. A user may activate said search of business using a voice command, a press of a button, or a search term entered in a text input box via a user interface of the end user device 306, 308. In some embodiments, the user would be given the option to populate the address book with one or more businesses listed.

Further with respect to FIG. 3, system 300 may also store and update geolocation information in database 304 for a plurality of mobile devices used by a plurality of users. In some embodiments, system 300 may provide a list of registered contacts along with their associated information that fall within a predetermined distance to a user device. For example, user device A 306 may be notified that it is in the vicinity of user device B 308 based on the geolocation information of each device stored in database 304. The user of user device A 306 will be given the choice whether to add a contact associated with user device B into his address book. In some embodiments, users will have a choice to turn on/off privacy settings with respect to disclosing their location at all, or only to certain classes of other users.

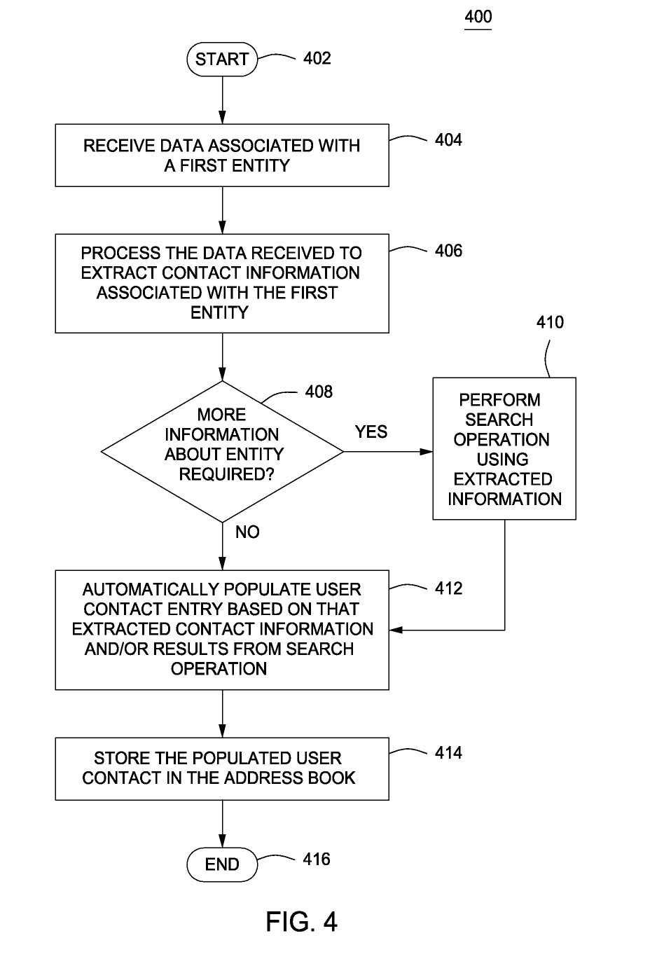

FIG. 4 depicts a flow diagram of a method 400 for obtaining and managing contact information for various entities, according to one or more embodiments of the invention. The method 400 starts at 402, and generally proceeds to 404.

At 404, data associated with an entity is received. As discussed above, the data associated with the entity may be received via various information transfer means 150. For example, in some embodiments, receiving the data associated with the entity includes capturing, using a camera such as 112, an image of data associated with the entity. In other embodiments, the data associated with the entity may be wirelessly transmitted from the entity.

At 406, the data received may be processed to extract the contact information associated with the entity. At 408, a determination is made whether more information about the entity is required. That is, the extracted information may contain ambiguous or incomplete data regarding the entity. For example, if the business establishment is part of a chain of similarly named stores, or a phone number is not part of the extracted data, a search operation using some of the extracted data would be conducted at 410 to obtain additional contact information. At 412, the extracted information and/or the additional search information would be used to automatically populate a user contact entry. The user would be given an option whether to store the contact, update the contact information, and or add additional information prior to storing the contact. At 414, the populated user contact would be stored in the address book.

Returning to 408, if enough contact information was extracted to sufficiently populate the contact entry, the method would proceed to 412 directly without performing the search operation to determined additional contact information at 410. The method 400 would proceed to 414 to store the populated user contact in the address book. The method 400 then ends at step 416.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

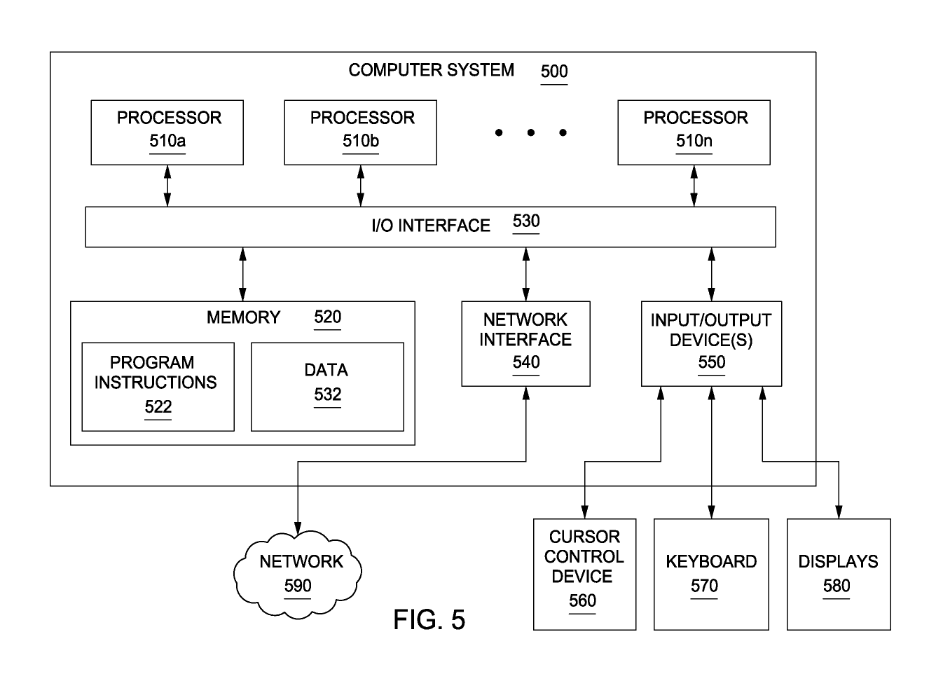

FIG. 5 depicts a computer system 500 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 500 illustrated by FIG. 5, which may in various embodiments implement any of the elements or functionality illustrated in FIGS. 1-7. In various embodiments, computer system 500 may be configured to implement methods described above. The computer system 500 may be used to implement any other system, device, element, functionality or method of the above-described embodiments. In the illustrated embodiments, computer system 500 may be configured to implement method 400 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the methods described above, such as the methods illustrated by the flowcharts of FIG. 3. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer-implemented method for populating a contact in an address book on a mobile computing device, the method comprising:
receiving data associated with a first entity;
processing the data received to extract contact information associated with the first entity;
populating a user contact entry based on the extracted contact information; and
storing the populated user contact in the address book.

2. The computer-implemented method of claim 1, wherein receiving data associated with the first entity includes capturing, using a camera associated with the mobile computing device, an image of data associated with the first entity, and wherein the image of the data captured is processed to extract the contact information associated with the first entity.

3. The computer-implemented method of claim 1, wherein the data associated with the first entity is in the form of plain-text language.

4. The computer-implemented method of claim 1, wherein the data associated with the first entity is in the form of a standardized code.

5. The computer-implemented method of claim 4, wherein the standardized code is one of a Quick Response (QR) code or a standard bar code.

6. The computer-implemented method of claim 2, wherein the contact information associated with the first entity is displayed on a sign proximate to or within the first entity.

7. The computer-implemented method of claim 2, wherein the contact information associated with the first entity is displayed on or proximate to a product associated with the first entity.

8. The computer-implemented method of claim 2, wherein the extracted contact information associated with the first entity is used as search criteria in a search engine to obtain further information about the first entity, and wherein the further information is used to populate the contact entry in the address book.

9. The computer-implemented method of claim 1, wherein receiving data associated with the first entity includes receiving data wirelessly transmitted from the first entity.

10. The computer-implemented method of claim 9, wherein the data is transmitted in a specific protocol recognized by the mobile computing device.

11. The computer-implemented method of claim 9, wherein the data is transmitted to the mobile computing device based on a proximity of the mobile computing device to the first entity.

12. The computer-implemented method of claim 1, wherein an end user of the mobile computing device is given an option whether to store the populated user contact in the address book.

13. The computer-implemented method of claim 1, wherein the first entity is one of a business establishment, a product display, a second mobile computing device, or a vehicle.

14. A computer-implemented method for obtaining, by a mobile computing device, contact information of one or more entities based on a location of the one or more entities in proximity to the end user device, the method comprising:
determining a set of entities that are within a wireless data transmission range from the mobile computing device;
sending contact information associated with the set of entities to the mobile computing device;
populating one or more user contact entries based on the contact information sent; and
storing the populated one or more user contact entries in an address book.

15. The computer-implemented method of claim 14, wherein an end user of the mobile computing device is giving an option whether to store the populated one or more user contacts in the address book.

16. The computer-implemented method of claim 14, wherein the wireless data transmission is performed using one of WiFi, BLUETOOTH, Radio-frequency identification (RFID) and Near Field Communications (NCF).

17. The computer-implemented method of claim 14, wherein the set of entities includes at least one of one or more business establishments or one or more other mobile computing devices.

18. The computer-implemented method of claim 14, further comprising:
performing a search operation on a database of geolocation information associated with a plurality of entities using geolocation information of the mobile computing device;
determining a second set of entities from the plurality of entities that are within a predetermined distance threshold from the mobile computing device;
sending contact information associated with the second set of entities to the mobile computing device;
populating one or more user contact entries based on the contact information sent; and
storing the populated one or more user contact entries in the address book.

19. Apparatus for populating a contact in an address book on a mobile computing device, the method comprising:
a) at least one processor;
b) at least one input device; and
c) at least one storage device storing processor-executable instructions which, when executed by the at least one processor, performs a method including
(1) receiving data associated with a first entity;
(2) processing the data received to extract contact information associated with the first entity;
(3) populating a user contact entry based on the extracted contact information; and
(4) storing the populated user contact in the address book.

20. The apparatus of claim 19, wherein receiving data associated with the first entity includes capturing, using a camera associated with the mobile computing device, an image of data associated with the first entity, and wherein the image of the data captured is processed to extract the contact information associated with the first entity.
